(19) United States
(12) Patent Application Publication
(10) Pub. No.: US 2007/0121862 A1
(43) Pub. Date: May 31, 2007

(54) Telephone exchange apparatus and incoming call control method for telephone exchange apparatus

(75) Inventor: Tamikazu Fuse, Atsugi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/521,309

(22) Filed: Sep. 15, 2006

(30) Foreign Application Priority Data
Sep. 16, 2005 (JP) 2005-271097

(51) Int. Cl. H04M 1/00

(52) U.S. Cl. 379/161

(57) ABSTRACT

According to one embodiment, a telephone exchange apparatus includes a memory which stores a management table in which a terminal ID of the first telephone terminal, the called party's ID, and a terminal ID of the second telephone terminal are associated with one another, when transfer registration is made to transfer the incoming call including the called party's ID to a second telephone terminal after the incoming call reservation key is pressed on the first telephone terminal, and a controller which refers to the management table based on the called party's ID and identifies the terminal ID of the first telephone terminal which is associated with the called party's ID based on a result of the reference, and performs incoming call control on the second telephone terminal which is associated with the terminal ID of the first telephone terminal, when the incoming call including the called party's ID arrives.

### CROSS-REFERENCE TO RELATED APPLICATIONS

This application is based upon and claims the benefit of priority from Japanese Patent Application No. 2005-271097, filed Sep. 16, 2005, the entire contents of which are incorporated herein by reference.

### BACKGROUND

1. Field

One embodiment of the invention relates to a telephone exchange apparatus having a function in which after an operation of making an outgoing call is performed on a telephone terminal, an incoming call reservation key provided on the telephone terminal is pressed, whereby an incoming call which arrives from a telephone terminal which is a destination of the outgoing call is accepted, on a priority basis, on the telephone terminal which is a source of the outgoing call, and an incoming call control method for the telephone exchange apparatus.

2. Description of the Related Art

In a telephone exchange apparatus such as a key telephone apparatus, when an outgoing call is made from an internal line terminal to a network, an outgoing telephone number of the internal line terminal which is a source of the outgoing call is notified to a telephone terminal on the network side which is a destination of an incoming call. It is assumed that the telephone terminal on the network side uses the outgoing telephone number and makes an outgoing call to the internal line terminal included in the telephone exchange apparatus. Then, the telephone exchange apparatus uniformly distributes, according to the outgoing telephone number included in an incoming call, the incoming call to a plurality of internal line terminals in a preset group.

In the telephone exchange apparatus, however, the incoming call is received and distributed within the group under the same condition and thus a user who is different from a user of the internal line terminal from which the outgoing call is made to the telephone terminal on the network may answer the incoming call. In this case, the user having received the incoming call needs to first make conversion with a caller and ask the caller whom he/she wants to and then have the user whom the caller wants to speak to take over the service or transfer the incoming call to a desired internal line terminal, causing a troublesome operation.

In view of this, conventionally, a following technique is proposed. That is, after a user on an internal line terminal performs an operation of making an outgoing call to a network, a specific key provided on the internal line terminal is pressed, whereby when a returned incoming call is received from a telephone terminal on the network side, the incoming call is received only by the internal line terminal where the specific key operation is performed (for example, Jpn. Pat. Appln. KOKAI Publication No. 2002-209238).

In the aforementioned technique, however, the user on the internal line terminal where the special key operation is performed may be away from his/her desk or may be out of the office. In this case, even if a returned incoming call is made to the internal line terminal where the specific key operation is performed, the call cannot be answered. Although there is a technique for transferring a returned incoming call to an internal line terminal at a location where the user in transit is present, transfer registration needs to be made separately and thus it is inconvenient.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of an exchange system according to a first embodiment of the present invention;

FIG. 2 is a diagram showing an example of contents stored in an outgoing history database shown in FIG. 1;

FIG. 3 is a schematic sequence diagram showing an operation of transmitting/receiving, when an outgoing call is made from an internal line terminal to a public network, information between the internal line terminal, a main apparatus, and an external telephone terminal in the first embodiment;

FIG. 4 is a flowchart showing procedures of a control process of a central control unit performed upon making registration to transfer an incoming call in the first embodiment;

FIG. 5 is a schematic sequence diagram showing an operation of transmitting/receiving, when an incoming call from the external telephone terminal on the public network arrives, information between the internal line terminal, the main apparatus, and the external telephone terminal in the first embodiment;

FIG. 6 is a flowchart showing procedures of a control process of the central control unit performed upon transferring an incoming call in the first embodiment; and

FIG. 7 is a flowchart, according to a second embodiment of the present invention, showing steps of a control process of the central control unit performed when an internal line terminal which is a destination of transfer of an incoming call cannot receive the call.

### DETAILED DESCRIPTION

Various embodiments according to the invention will be described hereinafter with reference to the accompanying drawings. In general, according to one embodiment of the invention, a telephone exchange apparatus which performs an exchange process between a plurality of telephone terminals, in which an operation of making an outgoing call is performed on a first telephone terminal among the plurality of telephone terminals and thereafter an incoming call reservation key provided on the first telephone terminal is pressed, whereby when an incoming call including a called party's ID which identifies a destination of the outgoing-call arrives, the first telephone terminal can accept the incoming call, the apparatus comprising: a memory which stores a management table in which a terminal ID of the first telephone terminal, the called party's ID, and a terminal ID of the second telephone terminal are associated with one another, when transfer registration is made to transfer the incoming call including the called party's ID to a second telephone terminal which is different from the first telephone terminal after the incoming call reservation key is pressed on the first telephone terminal; and a controller which refers to the management table based on the called party's ID and identifies the terminal ID of the first telephone terminal which is associated with the called party's ID based on a result of the reference, and performs incoming call control on the second telephone terminal which is associated with the terminal ID of the first telephone terminal, when the incoming call including the called party's ID arrives.

### FIRST EMBODIMENT

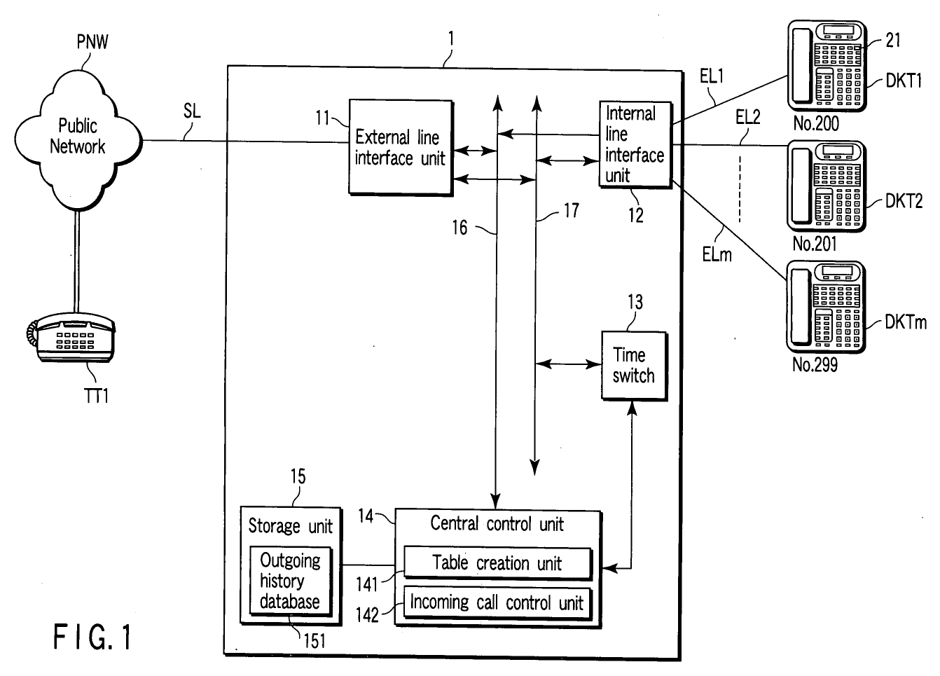

FIG. 1 is a block diagram showing the configuration of an exchange system according to a first embodiment of the present invention, in which reference numeral 1 denotes a main apparatus.

The main apparatus 1 includes an external line interface unit 11, an internal line interface unit 12, a time switch 13, a central control unit 14, and a storage unit 15. Among them, the external line interface unit 11, the internal line interface unit 12, and the central control unit 14 are interconnected to one another via a control bus 16. The external line interface unit 11, the internal line interface unit 12, and the time switch 13 are interconnected to one another via an audio bus 17.

The external line interface unit 11 is connected to a public network PNW via a subscriber line SL and performs, for example, a process of establishing a call with the public network PNW.

The internal line interface unit 12 includes a plurality of internal lines EL1 to ELm (m is a natural number). To the internal lines EL1 to ELm are connected internal line terminals DKT1 to DKTm, respectively. For the internal line terminals DKT1 to DKTm, digital key telephones, for example, are used. The internal line interface unit 12 performs, for example, an incoming/outgoing call process on the internal line terminals DKT1 to DKTm and a process of transferring a digital signal.

The time switch 13 performs, in response to an instruction from the central control unit 14, channel switching on a digital signal to be transmitted between the external line interface unit 11 and the internal line interface unit 12 via the audio bus 17.

The central control unit 14 performs, for example, an outgoing call process in response to a call request from the internal line terminals DKT1 to DKTm, a normal incoming call process in response to an external incoming call from the subscriber line SL, and a transfer process between the internal line terminals DKT1 to DKTm.

In the storage unit 15, control data necessary for control processes of the central control unit 14 is stored.

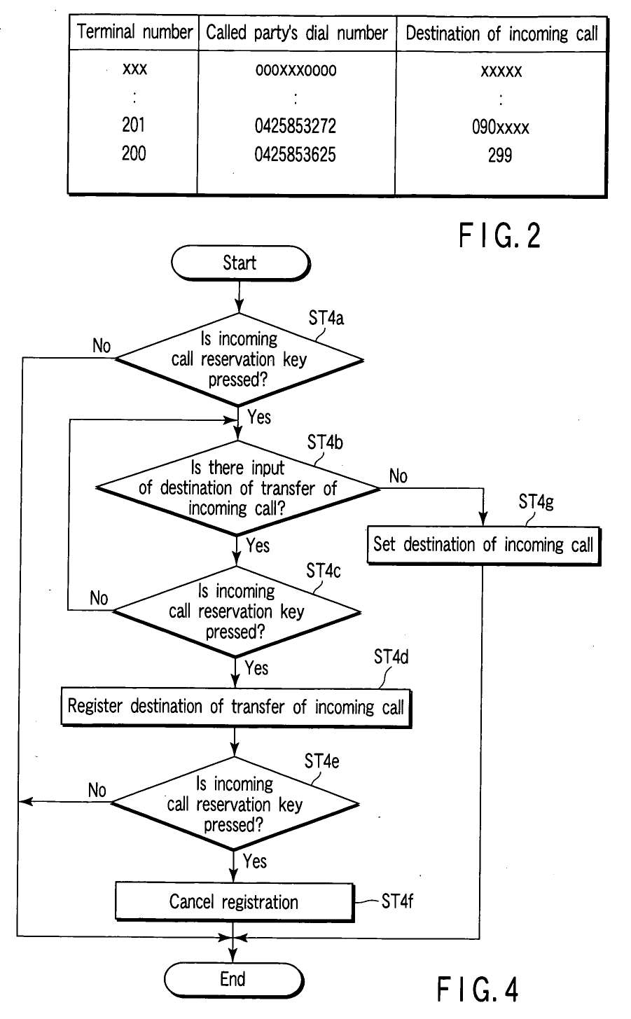

In the meanwhile, the central control unit 14 is configured to include a table creation unit 141 and an incoming call control unit 142 in the first embodiment. The table creation unit 141 creates a table in which, when an operation of making an outgoing call to the public network PNW is performed on the internal line terminal DKT1, for example, and thereafter an incoming call reservation key 21 for making a reservation for an incoming call is pressed to make registration to transfer an incoming call to the internal line terminal DKTm, a terminal number (200) which serves as a terminal ID of the internal line terminal DKT1, a called party's dial number which serves as an ID of a called party to which the outgoing call is made, and a terminal number (299) of the internal line terminal DKTm which is a destination of transfer of the incoming call are associated with one another. Then, the table creation unit 141 stores the table in an outgoing history database 151 of the storage unit 15. Note that in the outgoing history database 151, a table such as the one shown in FIG. 2 is stored.

When an incoming call including an outgoing telephone number arrives from the public network PNW, the incoming call control unit 142 determines whether the outgoing telephone number matches any of called parties' dial numbers stored in the outgoing history database 151. If it does, the incoming call control unit 142 identifies the terminal number of the internal line terminal DKT1 which is associated with the called party's dial number and performs incoming call control on the internal line terminal DKTm which is associated with the terminal number of the internal line terminal DKT1.

Now, the operation of a system configured in the above-described manner will be described.

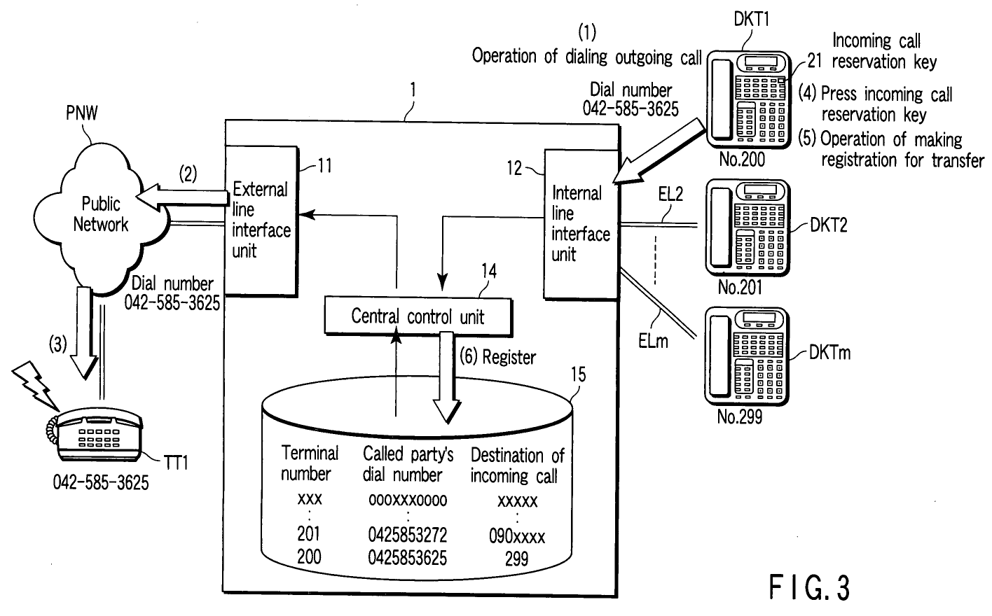

FIG. 3 is a schematic sequence diagram showing an operation of, when an outgoing call is made from the internal line terminal DKT1 to the public network PNW, transmitting/receiving information among the internal line terminal DKT1, the main apparatus 1, and an external telephone terminal TT1. FIG. 4 is a flowchart showing the procedures of a control process of the central control unit 14 performed upon making registration to transfer an incoming call.

It is assumed that a user on the internal line terminal DKT1 performs the operation of dialing a telephone number “042-585-3625” to make a call to a user on the external telephone terminal TT1. Then, a signal for requesting establishment of the communication is transmitted from the internal line terminal DKT1 to the main apparatus 1. Once the main apparatus 1 has received the communication establishment request signal, the main apparatus 1 transmits the communication establishment request signal to the public network PNW.

Once the public network PNW has received the communication establishment request signal, the public network PNW calls up the external telephone terminal TT1 which is the destination of an incoming call. Here, it is assumed that the external telephone terminal TT1, the destination of an incoming call, is busy or not answered within a certain period of time.

Then, it is assumed that in this state the user on the internal line terminal DKT1 presses the incoming call reservation key 21. In response to this, the central control unit 14 proceeds from block ST4a to block ST4b where input of data on the destination of transfer of the incoming call by the user is accepted.

Here, the user inputs, for example, “299” which is the terminal number of the internal line terminal DKTm. The central control unit 14 displays the inputted terminal number “299” on an LCD of the internal line terminal DKT1. When, in this state, the user presses the incoming call reservation key 21 on the internal line terminal DKT1, the central control unit 14 proceeds from block ST4c to block ST4d where a table is created in which the terminal number (200) of the internal line terminal DKT1, the called party's dial number, and the terminal number (299) of the internal line terminal DKTm which is the destination of transfer of the incoming call are associated with one another, and the table is stored in the outgoing history database 151 of the storage unit 15.

Thereafter, when the user presses the incoming call reservation key 21 on the internal line terminal DKT1, the central control unit 14 proceeds from block ST4e to block ST4f where the table which is stored in the outgoing history database 151 and in which the terminal number (200) of the internal line terminal DKT1, the called party's dial number, and the terminal number (299) of the internal line terminal DKTm which is the destination of transfer of the incoming call are associated with one another is deleted.

On the other hand, if, in the block ST4e, the user places the internal line terminal DKT1 on hook state, the central control unit 14 ends the process with the aforementioned table being registered in the outgoing history database 151.

If, in the block ST4a, the user places the internal line terminal DKT1 on hook without pressing the incoming call reservation key 21, the central control unit 14 ends the process there. If, in the block ST4b, after pressing the incoming call reservation key 21 on the internal line terminal DKT1 the user places the internal line terminal DKT1 on hook without inputting data on the destination of transfer of the incoming call, the central control unit 14 makes a setting as usual such that a returned incoming call from the external telephone terminal TT1 is received on the internal line terminal DKT1 (block ST4g).

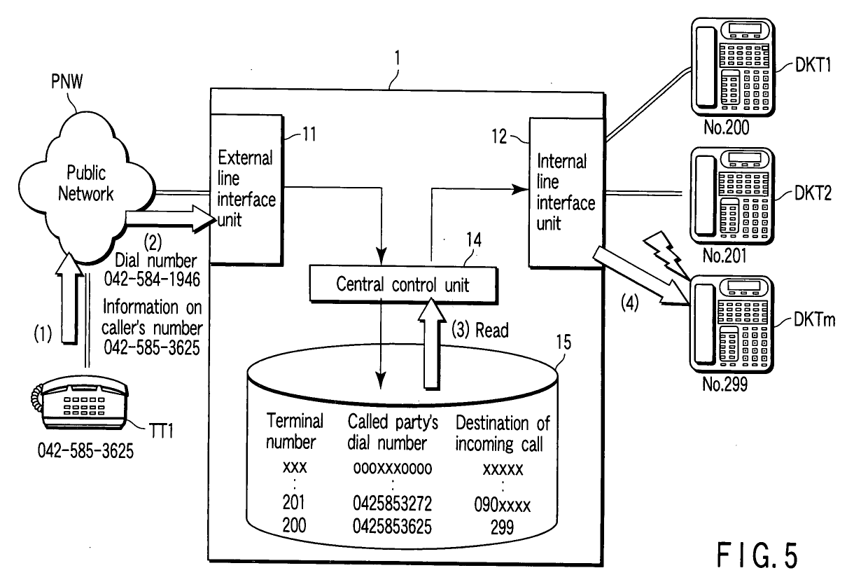

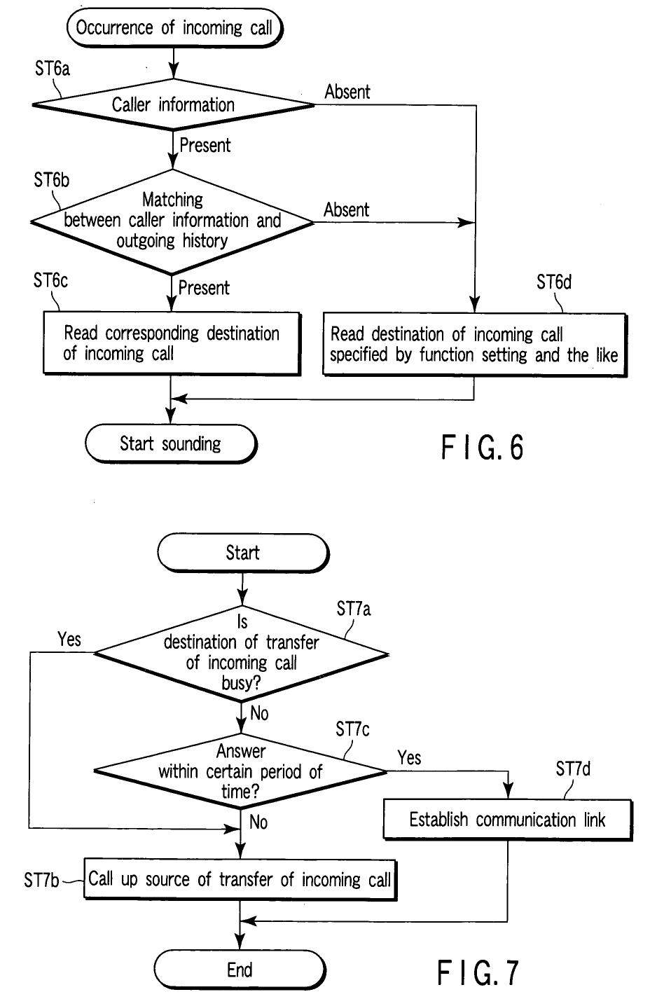

FIG. 5 is a schematic sequence diagram showing an operation of, when an incoming call from the external telephone terminal TT1 on the public network PNW arrives, transmitting/receiving information among the internal line terminal DKT1, the main apparatus 1, and the external telephone terminal TT1. FIG. 6 is a flowchart showing the procedures of a control process of the central control unit 14 performed upon transferring an incoming call.

Now, for example, as shown in FIG. 5, it is assumed that in response to an outgoing call from the external telephone terminal TT1, an incoming call which includes an outgoing telephone number arrives on the main apparatus 1 from the public network PNW.

In this case, the central control unit 14 of the main apparatus 1 determines whether an outgoing telephone number is included in the incoming call (block ST6a). If an outgoing telephone number is included (present), the central control unit 14 extracts the outgoing telephone number from the incoming call and determines whether the outgoing telephone number matches any of called parties' dial numbers stored in the outgoing history database 151 (block ST6b). In this example, since the dial number of the external telephone terminal TT1 is registered so as to be associated with the terminal number of the internal line terminal DKT1, the central control unit 14 reads from the outgoing history database 151 the destination of the incoming call which is associated with the outgoing telephone number (block ST6c) and transmits incoming call data to the internal line terminal DKTm which is the destination of the incoming call and allows the internal line terminal DKTm to generate an incoming call alarm. In this case, a ringtone different from that of the internal line terminal DKT1 sounds or a special message is displayed on a LCD.

If, in the block ST6a, an outgoing telephone number cannot be received or if, in the block ST6b, the outgoing telephone number is not registered in the outgoing history database 151, the central control unit 14 allows a destination of an incoming call specified by a usual function setting or the like to sound (block ST6d).

As described above, in the first embodiment, when an operation of making an outgoing call to the external telephone terminal TT1 is performed on the internal line terminal DKT1 and thereafter the incoming call reservation key 21 provided on the internal line terminal DKT1 is pressed to make transfer registration to transfer an incoming call including an outgoing telephone number of the external telephone terminal TT1 to the internal line terminal DKTm, the central control unit 14 of the main apparatus 1 stores a table in which the terminal number of the internal line terminal DKT1, a called party's dial number, and the terminal number of the internal line terminal DKTm which is the destination of transfer of the incoming call are associated with one another, in the outgoing history database 151 and manages the table. Then, when an incoming call including an outgoing telephone number from the external telephone terminal TT1 arrives, the central control unit 14 determines whether the outgoing telephone number matches any of called parties' dial numbers stored in the outgoing history database 151. If it does, the incoming call is automatically transferred to and received on the internal line terminal DKTm which is the destination of transfer of the incoming call.

Accordingly, on the internal line terminal DKT1, processes from making an outgoing call to the external telephone terminal TT1 to setting transfer to the internal line terminal DKTm can be performed at once. Therefore, with a small number of operations, a returned incoming call from the external telephone terminal TT1 can be received on the internal line terminal DKTm which is registered for transfer, whereby responses to individual callers can be efficiently made.

In addition, in the first embodiment, optimal incoming call control can be performed according to a registered called party's dial number in the central control unit 14 of the main apparatus 1. That is, when an outgoing telephone number included in an incoming call matches any of called parties' dial numbers stored in the outgoing history database 151, incoming call control can be performed on the internal line terminal DKTm which is registered for incoming call transfer. When it does not match, incoming call control is performed on a destination of an incoming call specified by a usual function setting or the like.

### SECOND EMBODIMENT

FIG. 7 is a flowchart, according to a second embodiment of the present invention, showing the procedures of a control process of the central control unit 14 performed when the internal line terminal DKTm which is the destination of transfer of an incoming call cannot receive the call.

It is assumed that an outgoing call is made from the external telephone terminal TT1 and in response thereto an incoming call including an outgoing telephone number arrives on the main apparatus 1 from the public network PNW. In this case, the central control unit 14 extracts the outgoing telephone number from the incoming call and makes a determination on the internal line terminal DKTm which is associated with the outgoing telephone number and which is the destination of the incoming call on the basis of the table in the outgoing history database 151.

Here, it is assumed that the internal line terminal DKTm is busy. Then, the central control unit 14 proceeds from block ST7a to block ST7b where the central control unit 14 transmits, with reference to the table in the outgoing history database 151, incoming call data to the internal line terminal DKT1 which is a source of transfer of the incoming call and allows the internal line terminal DKT1 to generate an incoming call alarm.

On the other hand, if the internal line terminal DKTm which is the destination of transfer of the incoming call is not busy but is not answered within a certain period of time, the central control unit 14 proceeds from block ST7c to block ST7b where the central control unit 14 transmits, with reference to the table in the outgoing history database 151, incoming call data to the internal line terminal DKT1 which is the source of transfer of the incoming call and allows the internal line terminal DKT1 to generate an incoming call alarm.

If, in the block ST7c, the internal line terminal DKTm is answered within the certain period of time, the central control unit 14 establishes a communication link between the internal line terminal DKTm and the external telephone terminal TT1 (block ST7d).

As described above, according to the second embodiment, when, for example, the user on the internal line terminal DKT1 is returned to a location where the internal line terminal DKT1 is installed from a location where the internal line terminal DKTm is installed, the user can answer a returned incoming call from the external telephone terminal TT1 on the internal line terminal DKT1.

### OTHER EMBODIMENTS

The present invention is not limited to the foregoing embodiments. For example, in the first and second embodiments, an example is described in which, when the destination of an outgoing call is busy and cannot answer the call, an incoming call reservation key on an internal line terminal which is a source of the outgoing call is pressed, whereby registration is made to transfer an incoming call to another internal line terminal. The present invention is, however, not limited thereto, and it is also possible that a call is made to the destination of the outgoing call and after the call is finished an incoming call reservation key on an internal line terminal which is a source of the outgoing call is pressed to make registration to transfer an incoming call to another internal line terminal.

Moreover, although in the foregoing embodiments an example in which an internal line terminal is specified as the destination of transfer of an incoming call, is described, it is also possible to specify a telephone terminal on a public network as the destination of transfer of an incoming call. By doing so, in the case in which the destination of transfer of an incoming call is a mobile phone, whatever the location, responses to individual callers can be made.

For the type (a PBX may be used instead of the main apparatus) and configuration of a telephone exchange apparatus, the type of an internal line terminal, the registration procedures for the destination of transfer of an incoming call, the procedures of controlling a returned incoming call, and the like, various modifications can be made without departing from the scope of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone exchange apparatus which performs an exchange process between a plurality of telephone terminals, in which an operation of making an outgoing call is performed on a first telephone terminal among the plurality of telephone terminals and thereafter an incoming call reservation key provided on the first telephone terminal is pressed, whereby when an incoming call including a called party's ID which identifies a destination of the outgoing call arrives, the first telephone terminal can accept the incoming call, the apparatus comprising:
a memory which stores a management table in which a terminal ID of the first telephone terminal, the called party's ID, and a terminal ID of the second telephone terminal are associated with one another, when transfer registration is made to transfer the incoming call including the called party's ID to a second telephone terminal which is different from the first telephone terminal after the incoming call reservation key is pressed on the first telephone terminal; and
a controller which refers to the management table based on the called party's ID and identifies the terminal ID of the first telephone terminal which is associated with the called party's ID based on a result of the reference, and performs incoming call control on the second telephone terminal which is associated with the terminal ID of the first telephone terminal, when the incoming call including the called party's ID arrives.

2. The telephone exchange apparatus according to claim 1, wherein the controller performs incoming call control on the first telephone terminal, when the controller is unable to perform incoming call control on the second telephone terminal.

3. The telephone exchange apparatus according to claim 1, wherein the controller compares the called party's ID included in the incoming call with called parties' IDs in the management table and only when there is a match, the controller identifies the terminal ID of the first telephone terminal which is associated with the called party's ID and performs incoming call control on the second telephone terminal which is associated with the terminal ID of the first telephone terminal.

4. An incoming call control method for a telephone exchange apparatus which performs an exchange process between a plurality of telephone terminals, in which an operation of making an outgoing call is performed on a first telephone terminal among said plurality of telephone terminals and thereafter an incoming call reservation key provided on the first telephone terminal is pressed, whereby when an incoming call including a called party's ID which identifies a destination of the outgoing call arrives, the first telephone terminal can accept the incoming call, the method comprising:
creating a management table in which a terminal ID of the first telephone terminal, the called party's ID, and a terminal ID of the second telephone terminal are associated with one another, when transfer registration is made to transfer the incoming call including the called party's ID to a second telephone terminal which is different from the first telephone terminal after the incoming call reservation key is pressed on the first telephone terminal; and
referring to the management table based on the called party's ID when the incoming call including the called party's ID arrives, identifying the terminal ID of the first telephone terminal which is associated with the called party's ID on the basis of a result of the reference, and performing incoming call control on the second telephone terminal which is associated with the terminal ID of the first telephone terminal.
